(19) United States
(12) Patent Application Publication
(10) Pub. No.: US 2005/0144441 A1
(43) Pub. Date: Jun. 30, 2005

(54) Presence validation to assist in protecting against Denial of Service (DOS) attacks

(76) Inventor: Priya Govindarajan, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/750,490

(22) Filed: Dec. 31, 2003

(51) Int. Cl. H04L 9/00

(52) U.S. Cl. 713/160

(57) ABSTRACT

In order to prevent, or at least reduce, attacks on a computing device, such as denial of service attacks against a computer, or other attempts to compromise computing device security, when desired, presence of a person or properly configured response unit may be determined prior to fully-establishing a network connection between the computer device and a connecting device. While one goal is to allow determining a person is directing the actions of the connecting device before fully establishing the network connection, it will be appreciated that in certain circumstances it may be desirable to allow automated connection obtained by the response unit, such to allow diagnostics, backups, updates, etc. to be performed with the computing device.

### FIELD OF THE INVENTION

The invention generally relates to computer security, and more particularly to performing presence verification before fully establishing a network connection with a connecting device.

### BACKGROUND

Security attacks, such as Denial of Service (DOS) attacks, security exploits, and other security attacks (generally referenced hereinafter as “attacks”) may result in significant financial loss due to machinery downtime, hardware damage, as well as damage to intangible assets, such as reputation and peer standing. Attacks are often simple to create, and the growing numbers of automated tools that are available to “script kiddies” increase the magnitude of an attack. (“Script kiddies” are attackers with limited or no technical knowledge that are interested in using an attack crafted by another.)

Attacks are frequently distributed ready to be applied, and hence they can easily be used to attack and/or compromise machines in multiple distributed domains, resulting in widespread damage. An example of a DOS attack is the TCP SYN attack in which a server is led to believe a valid connection attempt is being made. A valid TCP/IP connection requires engaging in a three-way handshake to establish the connection. In response to initial contact to establish a connection, a server allocates resources for this connection, but the attacker never completes the three-way handshake and instead the attacker typically attempts to establish another connection. In short order, the server runs out of resources and can no longer process valid connection attempts. Service is thus denied to valid clients. There are many other attacks that may be used to attack a computer.

### BRIEF DESCRIPTION OF THE DRAWINGS

The features and advantages of the present invention will become apparent from the following detailed description of the present invention in which:

FIG. 1 illustrates according to one embodiment a high-level flowchart for monitoring for overrun attacks of a protected server.

FIG. 2 illustrates an exemplary system of machines operating in accordance with the FIGS. 1, 3 and 4 embodiments.

FIG. 3 illustrates a data flow diagram according to one embodiment.

FIG. 4 illustrates a flowchart according to one embodiment for monitoring network traffic for suspicious activity and responding thereto.

FIG. 5 illustrates a suitable computing environment in which certain aspects of the invention may be implemented.

### DETAILED DESCRIPTION

It will be appreciated that many different approaches may be taken to reduce or eliminate the effectiveness of certain types of attacks. For example, in the TCP/IP DOS attack described above, one may protect a server from such half-open connections by having a proxy or Network Address Translator (NAT) respond for the server and act as a middleman for connections that are established, or by using a stateless three-way handshake in which the server, rather than using local resources to track connection state information, instead embeds the connection state information into its response to an incoming TCP SYN packet starting the three-way handshake.

Unfortunately, while the middle-man and stateless approaches minimize damage from the half-open connection attack, another way to overburden a server is to employ an “overrun” attack. In this attack, multiple valid connections are established with the server, after which the server is overrun with data transfer requests on the multiple valid connections, thus rendering the server incapable of adequately responding to request from legitimate clients. For example, a server typically offers many known services such as a web server, File Transfer Protocol (FTP) server, electronic mail, news, etc. Many valid connections may be made, for example, to a server's web service ostensibly to obtain web data, but once a connection is established, a connection is manipulated to constantly request data from the server's service. Such attacks may even be facilitated by directory services such as Universal Description, Discovery and Integration (UDDI) or other directory services, which publicly disclose services offered by the server that are available to be attacked.

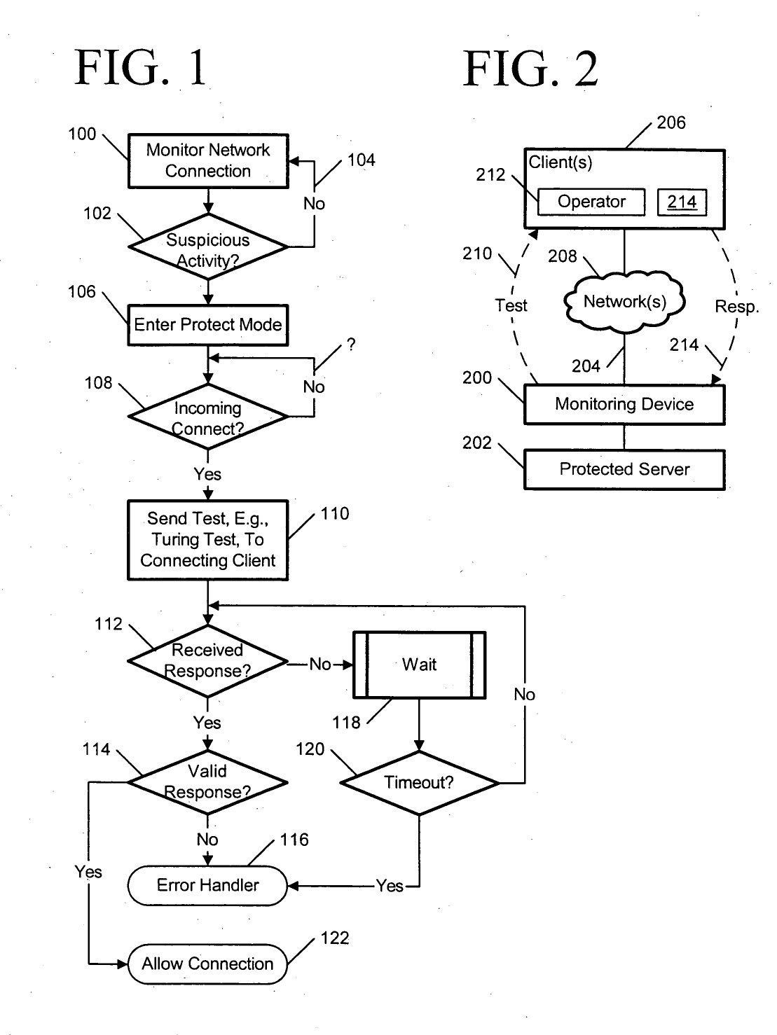

To protect against overrun attacks, another layer of protection may be employed. FIG. 1 illustrates, according to one embodiment, a high-level flowchart for monitoring for overrun attacks. FIG. 1 is discussed with respect to machines illustrated in an exemplary system shown in FIG. 2.

A monitoring device 200, such as a firewall, a NAT router, gateway, network interface card (NIC) or network adapter of a protected server 202, etc. may be configured to monitor 100 a network connection 204 for suspicious network communication with the server from unknown clients 206. For example, the protected server may be in communication with a public network 208, such as the Internet, by way of the monitored network connection 204. If 102 no suspicious activity is identified, processing loops 104. It will be appreciated that various tasks, not illustrated, may be performed when looping.

However, if 102 the monitoring device 200 detects suspicious activity, e.g., indicia of an ongoing attack on a protected server 202, such as incident to a DOS attack, or a report of an attack on a related server (not illustrated), such as another server in a cluster of servers, then the monitoring device enters 106 a “protect mode.” When in protect mode, if 108 a network connection is established by a client 206, this triggers sending 110 a test 210, e.g., a “Turing test,” to the client for evaluation by a person presumed to be operating the client (hereafter “operator” 212).

The test is designed so that completion of the test is trivial for a person but difficult if not impossible for an automated device to decipher. For example, the test could be identifying an ASCII art representation of a number (a number pictorially displayed as an arrangement of ASCII characters), determining a number hidden in a graphic image, etc. Successful completion of the test validates the operator's presence and hence suggests the network connection is not part of an automated attack on the protected server. If 108 a connection is not being performed, some other action, such as a wait loop or other action (not illustrated) may take place.

If 112 a response 214 is received from the client 206 responsive to the test 210, the response is validated 114 for correctness. If the response is incorrect, an error handler may be called 116; error handling details are not illustrated but may comprise repeating some number of times the illustrated sending 110 of a test and validating 114 responses. If 112 a response is not received, a timeout 118 may be employed to limit the amount of time spent waiting for a response. If 120 the wait times out, then the error handler may be called 116. If the wait has not time out, processing continues with a test to see if 112 a response has been received. It will be appreciated various wait times may be employed to allow sufficient time for an operator to answer a particular test question.

If 112a response was received, and if 114 the response was correct, then communication between the protected server 202 and client is allowed 122. For example, if the client had been requesting data from the protected server, such as for a data file or for the content of a web page, the data request is forwarded to the protected server for processing. If 114 the response was wrong, in the illustrated embodiment, processing ends with the error handler 114. It will be appreciated that in an alternate embodiment, processing may loop back to again providing 110 the client 206 operator 212 with a test, where this may be the same test, or a different test. It will be further appreciated that some embodiments may allow a limited number of attempts to get the test answer correct before the client is blocked from accessing the protected server.

In one embodiment, assuming the standard ISO-OSI 7 layer Reference Model (ISO Standard 7498-1:1994), various aspects of the FIGS. 1 and 2 embodiments may be practiced at different networking layers. That is, in order for the monitoring device to monitor network connections, the monitoring device may operate at ISO layer 4 (or lower). In contrast, in order for the client operator 212 to interact with the test 210 sent 110 by the monitoring device, the operator must use an ISO layer 7 application program, e.g., the interface of an Internet browser.

To facilitate this interaction, in one embodiment, the client 206 may optionally include a module 214 (shown in dashes as it is optional), such as an extension to the client's networking services, which monitors received network data for tests 210. Assuming an appropriate protocol is known for sending and identifying received tests, the module automatically causes display of an interface in which a test answer may be entered, such as by executing code to display a new browser window containing the test and an area in which to enter an answer to the test. In this embodiment, client networking software, e.g., Internet browsers, file transfer programs, etc. need not be modified to work with a protected server so long as the test interface can be automatically displayed by the module to an operator.

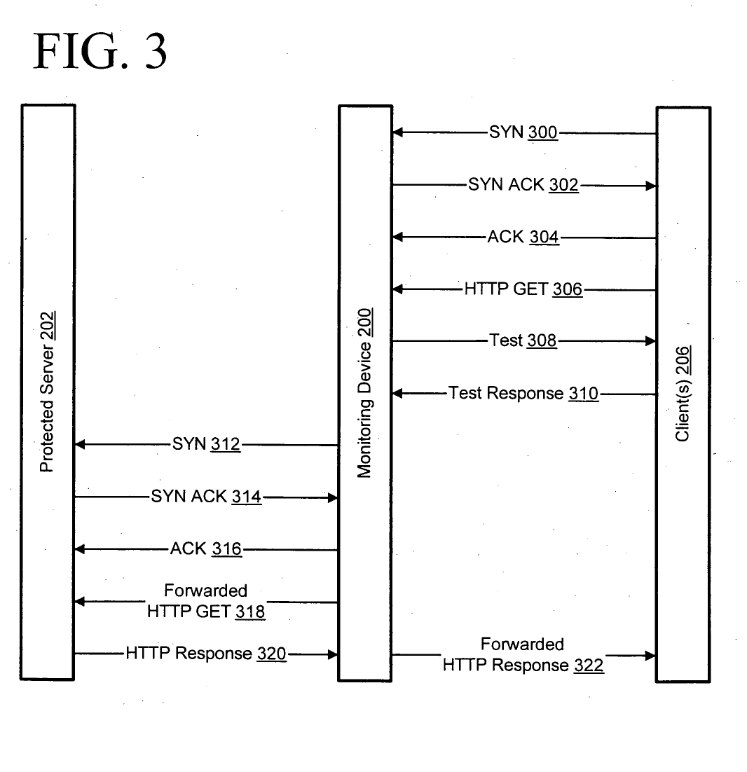

FIG. 3 illustrates a data flow diagram according to an alternative embodiment to FIG. 1 in which the client 206 does not have any special module 214 in order to respond to the test. Instead, in this embodiment, the client is presumed to be communicating with the server 202 with an application capable of directly receiving and displaying the test. For example, after successfully completing the TCP three-way SYN 300/SYN ACK 302/ACK 304 handshake, assuming the client utilizes an Internet browser, the monitoring device 200 should receive an initial HTTP GET request 306. It will be appreciated that the GET request is particularly identified for exemplary purposes only and that other data access requests are contemplated.

However, rather than a protected server 202 directly receiving the GET request as would conventionally be performed in a direct connection between a client 206 and the protected server, instead the monitoring device caches the GET request and instead sends 308 the client the test 210, e.g., a Turing test. Since many attacks are automated in order to increase destructive effectiveness, the test 210 need only be as complicated as necessary to determine if a person is operating the client.

In the illustrated embodiment, the protected server is unaware of the attempt(s) by the client(s) 206 to contact the protected server until the client has successfully sent a correct response 310 to the test 308. If the client does not successfully answer the test, or if an automated agent gives a wrong answer to the test, the monitoring device may discard the initial request 306 without disturbing the protected server. However, if a correct response to the test is received 310, in the illustrated embodiment, the monitoring device 200 initiates a connection with the protected server by sending 312 an initial SYN packet. The protected server and monitoring device may then complete the remaining SYN ACK 314 and ACK 316 operations of the three-way handshake to establish a connection between the monitoring device and the server.

After establishing a connection between the monitoring device 200 and the protected server 202, the monitoring device can then forward 318 the cached initial GET request from the client 206 to the protected server for processing. Any HTTP response sent 320 by the protected server is received by the monitoring device and forwarded 322 to the client 206. The illustrated embodiment presumes the monitoring device transparently operates as a middleman for communications between the client(s) and the protected server, e.g., a client and protected server need not know they are communicating by way of a middleman. However, it will be appreciated by one skilled in the art that various techniques may be employed to arrange for the protected server and client to directly communicate once the client has successfully passed the test 308.

It will be further appreciated that various caching techniques may be employed to cache the initial GET request, as well subsequent requests, if any, received while awaiting successful completion of the test 308 sent responsive to the initial GET. In particular, since many network application programs are optimized to make multiple simultaneous connections, e.g., Internet browsers typically establish multiple TCP connections to a server for different objects of a web page, in one embodiment a “white list” is maintained by the monitoring device 200 to track clients 206 that have previously passed a test 210.

Thus, rather than a client receiving multiple tests for each separate connection, instead, after a correct test response is received 310, the client is added to the white list indicating the client may communicate without being challenged again. All cached requests for the client may also be processed once entry is made on the list. However, since a client may later become compromised, it will be appreciated there may be a limit on duration on the list, e.g., the client may be removed after a certain amount of time, or when an end of communication is detected, e.g., a protocol command signaling end of a session is seen, etc. Similarly, a “black list” may be employed to track clients or network addresses that can never be allowed to communicate with a protected server, including known spammers, broadcast addresses, multicast addresses, non-routable addresses, and other addresses that should not be normally seen by the protected server.

Since the illustrated monitoring device 200 is itself susceptible to DOS and other attacks, in one embodiment of the FIG. 3 embodiment, as discussed above, the monitoring device may utilizes a stateless protocol at least with respect to the three-way handshake 300, 302, 304 between the monitoring device and the client 206. By not maintaining state information for client 206 connections until the test response 310 is received, the stateless protocol may help protect resource exhaustion at the monitoring device. For a stateless protocol example, the monitoring device may use the SYN ACK sequence number it generates responsive 302 to the received 300 SYN packet as part of the test.

For example, assuming the test 210 requires interpreting an ASCII art number, the ASCII art may encode the responsive 302 sequence number. Since the client 206 is now responsible for returning this sequence number back to the monitoring device 200 to successfully answer the test, the monitoring device need not maintain state to track the three-way handshake 300, 302, 304. For security, cryptographic techniques may be employed to prevent tampering with the encoded sequence number, or insertion of a masquerading device in the communication stream between the monitoring device and the client. For example, the responsive sequence number may be computed modulo a secret key that changes randomly or otherwise in a way likely predictable only by the monitoring device. When the monitoring device receives 310 the test response, it may perform an appropriate inverse operation to recover the responsive 302 sequence number.

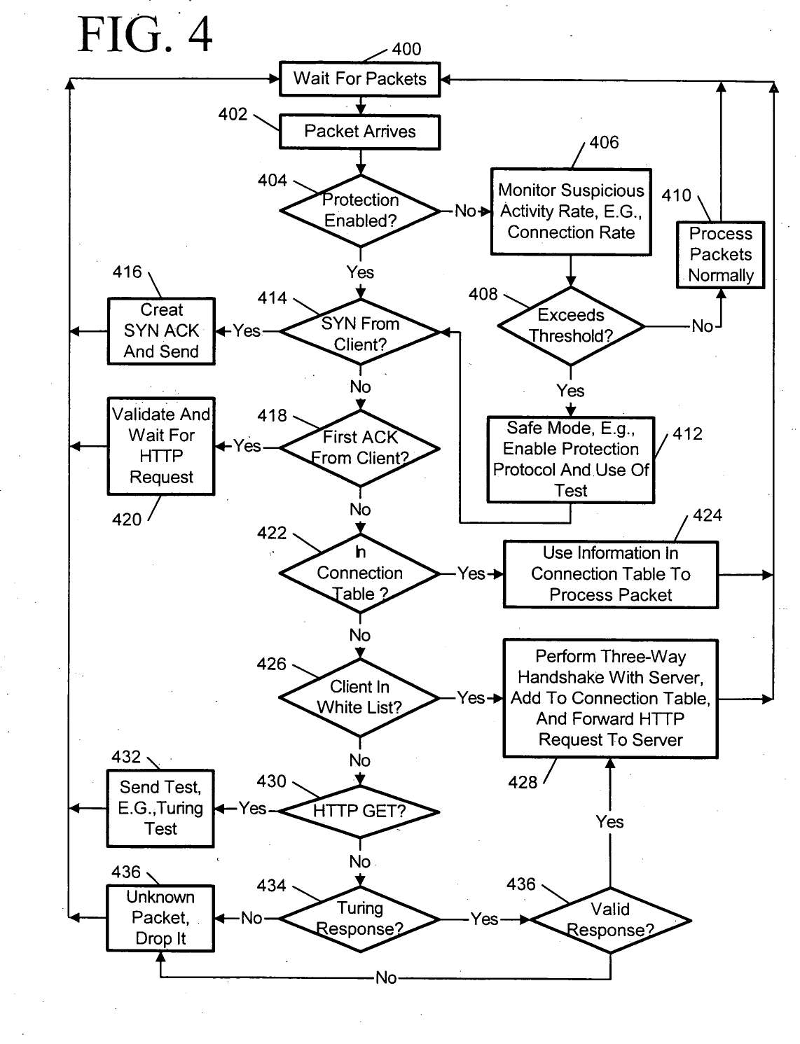

FIG. 4 illustrates a flowchart according to one embodiment for monitoring, such as by the FIG. 2 monitoring device 200, of network traffic for suspicious activity.

Initially packets are waited 400 on for arrival; it will be appreciated waiting may comprise taking other actions not illustrated, or waiting may be relegated to a particular operation thread or task dedicated to waiting for network packets. It is also intended that the term “packet” and its variants include any technique for encapsulating digital data for transmission in accord with a particular transmission medium.

When a packet 402 arrives, a test 404 is performed to determine whether a protection protocol is already in effect for establishing network connections, e.g., whether a stateless protocol is already being used in performing the three-way TCP/IP handshake. If 404 not, the rate of activity is monitored 406, e.g., various activities, such as the number of incoming connections (could indicate a DOS attack) or other network characteristic, is monitored. If 408 the amount of activity does not exceed a threshold (which could vary from server to server and hence will be configurable by the server operator), for example 5000 attempted connections per second, then in the illustrated embodiment, packets are processed 410 normally and processing loops back to waiting 400 for more packets.

However, if 408 the amount of activity does exceed the threshold, in the illustrated embodiment, processing enters a “Safe Mode,” e.g., a connection protection protocol such as a stateless connection protocol is enabled 412 for use in processing connection attempts (to prevent a DOS type of attack), and a test, e.g., a Turing test, will be used responsive to certain data access requests. Thus, if 414 a SYN packet is received from a connecting client when the illustrated embodiment is operating in Safe Mode, a responsive SYN ACK is created 416 in accord with the stateless protocol and sent, e.g., connection state information may be encoded in the SYN ACK and not retained. Processing then loops to waiting 400 for more packets.

If 414 a SYN packet was not received, then a test is performed to determine if 418 a first ACK has been received from a client. If so, then the ACK is validated 420 and the illustrated embodiment is then ready to receive a data access request, such as an HTTP request. It will be appreciated HTTP accesses are presented for illustrative purposes only. In one embodiment, validation comprises decoding the response to a SYN ACK created 416 in accord with the stateless protocol. For example, connection information minimally includes at least origin and destination TCP/IP addresses and communication ports and a secret known to the server proxy, and this information can be encoded (and possibly encrypted) and represented as a SYN ACK value. Validation then may comprise subtracting 1 from the received ACK (TCP/IP connection handshake requires the client to increment the SYN ACK by 1), and comparing this value against a recalculation of the encoding of the connection state and the secret.

If 418 the ACK is not the first ACK received from a client, then a test is performed to determine if 422 the client is listed in a Connection Table identifying clients that already have associated established network connections between a monitoring device such as the FIG. 2 monitoring device 200 and a protected server, e.g., clients known to have completed a three-way handshake with the monitoring device and to have passed the test. If 422 so, then the existing connection table information is used to process the received packet. Since the connection to the server is established by the NAT-like device after the client has been validated, there are some fields in the packet, for example, the ACK and sequence numbers, that need to be updated before the packet is sent to the server. Processing then loops to waiting 400 for more packets.

If 422 the client is not already in the Connection table, a test is performed to determine if 426 it is in a “White List” identifying clients known to be trustworthy, e.g., the test is not necessary (it will be appreciated many trust models may be employed to determine a trustworthy client). If 426 the client is trustworthy, then a TCP/IP three-way handshake is performed 428 between the monitoring device and the protected server (see, e.g., FIG. 3 items 312-316), the connection is added to the Connection Table, and the clients HTTP request is forwarded (see e.g. FIG. 3 items 306, 318) to the protected server. Processing then loops to waiting 400 for more packets.

If 426 the client was not in the White List, then a test is performed to determine if 430 an HTTP GET request has been received. (It will be appreciated that an HTTP GET request is used here only for illustrative purposes, and that other protocols may also be supported as described herein.) If so, since the client is not in the Connection Table, and is not known to be trustworthy, the client is sent 432 the test, e.g., a Turing test, to ensure that the client is not under the control of some automated malicious program attacking the protected server. In one embodiment, the client is sent a web page comprising a graphic image of a number (e.g., an ASCII art representation of a number, photo of a number, etc.) or other feature to be recognized by a person, along with a form which may be filled out to indicate a response to the test. Processing then loops to waiting 400 for more packets, e.g., for a response to the test.

If 430 an HTTP GET was not received, a test is performed to determine if 434 the packet corresponds to a response to the test. If 436 not, then the packet it unknown and in the illustrated embodiment it is dropped/discarded. However, it will be appreciated that other embodiments may employ other tests not illustrated before determining a packet is unknown and to be dropped. If 434 however the received packet is a test response, then a test is performed to determine if 438 the response is valid. As discussed above, validity of a response depends on the nature of the test. If the response is valid, then the connection between the monitoring device and the server is performed 428 as discussed above.

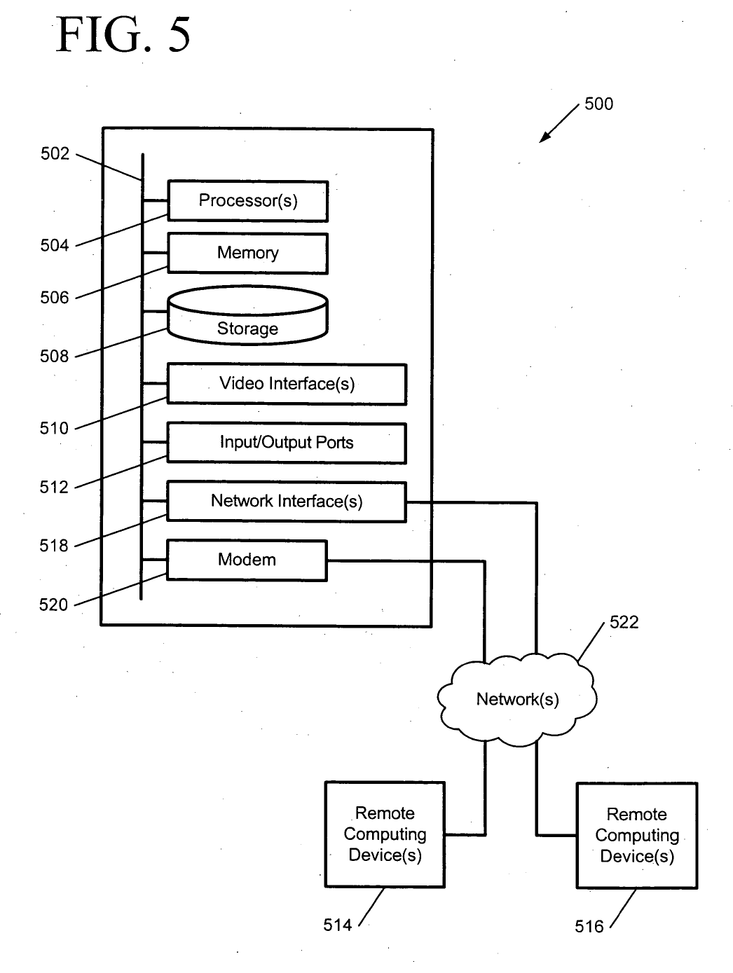

FIG. 5 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., as well as transportation devices, such as private or public transportation, e.g., automobiles, trains, cabs, etc.

Typically, the environment includes a machine 500 that includes a system bus 502 to which is attached processors 504, a memory 506, e.g., random access memory (RAM), read-only memory (ROM), or other state preserving medium, storage devices 508, a video interface 510, and input/output interface ports 512. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 514, 516, such as through a network interface 518, modem 520, or other communicative coupling. Machines may be interconnected by way of a physical and/or logical network 522, such as the network 208 of FIG. 2, an intranet, the Internet, local area networks, and wide area networks. One skilled in the art will appreciated that communication with network 522 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, volatile and/or non-volatile memory 506, or in storage devices 508 and their associated storage media, including hard-drives, floppy-disks, optical storage, tapes, flash memory, memory sticks, digital video disks, biological storage, etc. Associated data may be delivered over transmission environments, including network 522, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 500 embodies the monitoring device 200 of FIG. 2, then remote machines 514, 516 may be a unknown connecting clients, e.g., FIG. 2 client 206. It will be appreciated that remote machines 514, 516 may be configured like machine 500, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

1. A method for a network, comprising:
determining suspicious network activity on the network;
receiving an initial packet from a first machine for establishing a communication session between the first machine and a second machine;
sending a test to the first machine, the test having at least one characteristic making the test resistant to automatic answering of the test; and
establishing the communication session between the first and second machines after a valid response is received to the test.

2. The method of claim 1 further comprising responding to the initial packet from the first machine by sending a response packet to the first machine encoding a connection state for establishing the communication session.

3. The method of claim 2 wherein the initial packet is a SYN packet in accord with the TCP protocol and the response packet is a SYN ACK packet in accord with the TCP protocol.

4. The method of claim 3, wherein the SYN ACK comprises a number encoding a first address for the first machine on the network, and a second address for the second machine on the network.

5. The method of claim 2, wherein the connection state of the response packet comprises a number encoding a first address for the first machine on the network, a second address for the second machine on the network, and a secret unknown to the first machine to facilitate validating an acknowledgement from the first machine responsive to the response packet.

6. The method of claim 1, further comprising:
receiving an acknowledgement packet from the first machine responsive to the response packet;
decoding a tentative connection state information from the acknowledgement packet; and
determining if the tentative connection state information is valid.

7. The method of claim 1, further comprising:
preparing a web page embodying the test; and
said sending the test to the first machine including sending the web page to a networking application program of the first machine, the networking application program operative to receive and display the web page.

8. The method of claim 1, wherein the test is embodied within a web page.

9. The method of claim 1, further comprising:
monitoring by a monitoring device of attempts to establish communication sessions with the second machine;
wherein the establishing the communication session between the first and second machines includes the monitoring device establishing a first connection between the monitoring device and the first machine, and the monitoring device establishing a second connection between the monitoring device and the second machine.

10. The method of claim 1, further comprising:
monitoring by a monitoring device of attempts to establish communication sessions with the second machine;
wherein the establishing the communication session between the first and second machines includes the monitoring device storing an identifier for the first machine in a list identifying machines that have provided the valid response.

11. A method for a monitoring device to facilitate communication between a client and a protected server, comprising:
receiving a first packet from the client to begin a handshake for establishing a first network connection between the client and the intermediary;
sending a second packet to the client to acknowledge the first packet;
receiving a third packet from the client acknowledging the second packet;
receiving a data access request from a networking application program of the client; and
sending a test to the networking application program, the test having at least one characteristic making the test resistant to automatic answering of the test.

12. The method of claim 11, further comprising:
receiving a response to the test from the client;
determining the response comprises a valid answer to the test;
establishing a second network connection between the monitoring device and the protected server; and
facilitating communication between the client and the protected server.

13. The method of claim 11, wherein the monitoring device does not allocate resources for tracking a state information for establishing the first network connection and instead encodes the state information within the second packet.

14. The method of claim 11, wherein the third packet encodes a known alteration of the state information.

15. The method of claim 11, wherein the data access request is a GET request formatted with respect to HyperText Transport Protocol (HTTP).

16. The method of claim 11, wherein the networking application program includes a web browser, and the test comprises a web page incorporating the test.

17. A system, comprising:
a protected server responsive to network connection requests;
a client machine seeking to establish communication with the protected server; and
a monitoring device communicatively interposed between the protected server and the client machine, wherein the monitoring device is configured to send a test resistant to automatic answering to the client machine, and to facilitate establishing the client machine communication with the protected server if a valid response to the test is received by the monitoring device.

18. The system of claim 17, wherein the monitoring device is further configured to perform:
receiving an initial packet from the client machine for establishing a communication session; and
responding to the initial packet by sending a response packet to the client machine encoding a connection state for establishing the communication session.

19. An article comprising a machine-accessible media having associated data, wherein the data, when accessed, results in a machine communicatively coupled with a network performing:
determining suspicious network activity on the network;
receiving an initial packet from a first machine for establishing a communication session between the first machine and a second machine;
sending a test to the first machine, the test having at least one characteristic making the test resistant to automatic answering of the test; and
establishing the communication session between the first and second machines after a valid response is received to the test.

20. The article of claim 19 wherein the machine-accessible media further includes data, when accessed, results in the machine performing:
responding to the initial packet from the first machine by sending a response packet to the first machine encoding a connection state for establishing the communication session.

21. An article comprising a machine-accessible media having associated data for a monitoring device to facilitate communication between a client and a protected server, wherein the data, when accessed, results in a machine performing:
receiving a first packet from the client to begin a handshake for establishing a first network connection between the client and the intermediary;
sending a second packet to the client to acknowledge the first packet;
receiving a third packet from the client acknowledging the second packet;
receiving a data access request from a networking application program of the client; and
sending a test to the networking application program, the test having at least one characteristic making the test resistant to automatic answering of the test.

22. The article of claim 21 wherein the machine-accessible media further includes data, when accessed, results in the machine performing:
receiving a response to the test from the client;
determining the response comprises a valid answer to the test;
establishing a second network connection between the monitoring device and the protected server; and
facilitating communication between the client and the protected server.
